(19) United States
(12) Patent Application Publication
(10) Pub. No.: US 2014/0330649 A1
(43) Pub. Date: Nov. 6, 2014

(54) Displaying Targeted Advertisements to Users

(71) Applicants: Philip Scott Lyren, Bangkok (TH); Robert Louis Lyren, Bangkok (TH)

(72) Inventors: Philip Scott Lyren, Bangkok (TH); Robert Louis Lyren, Bangkok (TH)

(21) Appl. No.: 13/875,308

(22) Filed: May 2, 2013

(51) Int. Cl. G06Q 30/02; G06Q 50/00

(52) U.S. Cl. CPC G06Q 30/0269; G06Q 50/01
USPC 705/14.66

(57) ABSTRACT

A targeted advertisement is retrieved for a first user, and a targeted advertisement is retrieved for a second user. The targeted advertisements are switched such that the targeted advertisement intended for the first user plays on a display of an electronic device of the second user, and the targeted advertisement intended for the second user plays on a display of an electronic device of the first user while the first and second users communicate.

### BACKGROUND

Advertisers expend large amounts of resources to drive consumer behavior with respect to a particular product or service. Online advertisers utilize a wide range of advertising techniques in an attempt to attract attention and persuade consumers. Often, these advertising techniques are inefficient or ineffective since consumers are inundated with advertisements.

### BRIEF DESCRIPTION OF THE DRAWINGS

FIG. 1 is a computer system in accordance with an example embodiment.

FIG. 2 is a method to switch targeted advertisements between users in accordance with an example embodiment.

FIG. 3 is a computer system in which electronic devices switch and/or follow advertisements in accordance with an example embodiment.

FIG. 4 is a method to follow and/or switch targeted advertisements among users in accordance with an example embodiment.

FIG. 5 is an electronic device with a display that shows a social networking website of a user that switched and/or follows advertisements with another user in accordance with an example embodiment.

FIG. 6 is a method to follow and/or switch advertisements among users in accordance with an example embodiment.

FIG. 7A is an electronic device with a display that shows searching and selecting individuals for advertisement following and/or advertisement switching in accordance with an example embodiment.

FIG. 7B is the electronic device of FIG. 7A that shows additional information about one of the selected users being followed in accordance with an example embodiment.

FIG. 7C is the electronic device of FIG. 7A that shows advertisement notifications settings and/or options and advertisement display settings and/or options in accordance with an example embodiment.

FIG. 7D is the electronic device of FIG. 7A that shows sharing advertisements of the selected users with other users in accordance with an example embodiment.

FIG. 7E is an electronic device with a display that shows advertisement filtering in accordance with an example embodiment.

FIG. 8 is a method to reshuffle or change an order in which plural followed and/or switched advertisements are displayed to users in accordance with an example embodiment.

FIG. 9 is an electronic device in accordance with an example embodiment.

### SUMMARY OF THE INVENTION

One example embodiment is a method that enables members of a group to participate in advertisement following in which the members can view advertisements that other members are currently viewing and view advertisements that other members previously viewed. A first member receives targeted advertisements that are directed a second member. The first member is provided with a notice that indicates the targeted advertisements are directed to the second member.

### DETAILED DESCRIPTION

Example embodiments include systems, apparatus, and methods that follow and/or switch advertisements between users.

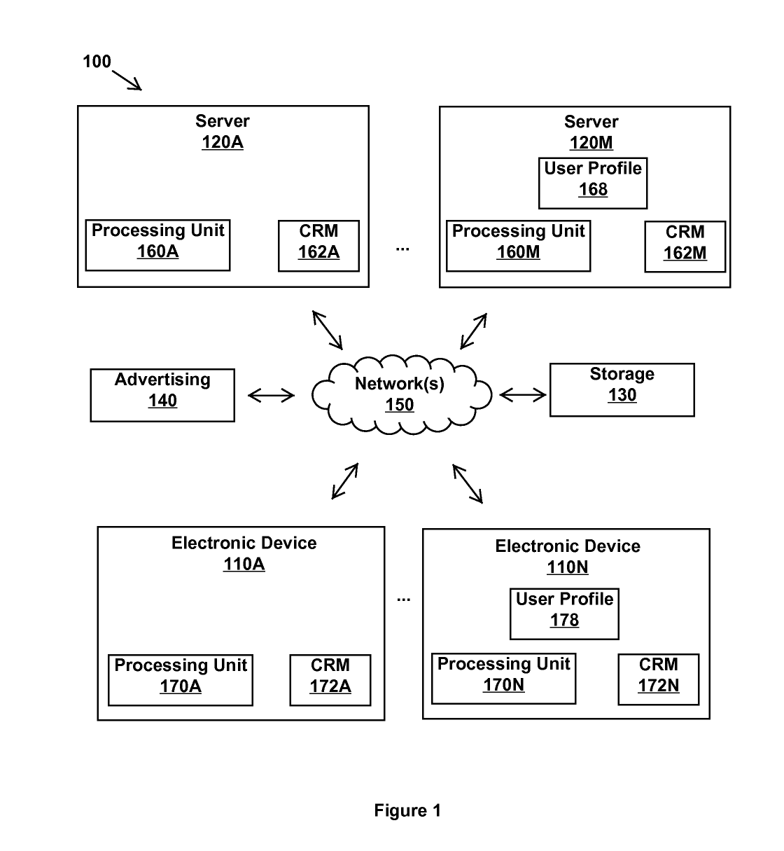

FIG. 1 is a computer system 100 in accordance with an example embodiment. The computer system includes a plurality of electronic devices 110A to 110N, a plurality of servers 120A to 120M, storage 130, and advertising 140 in communication with each other through one or more networks 150. Blocks and methods discussed herein are executed with the computer system or one or more of the electronic devices, servers, and/or components therein.

The servers 120A to 120M include a processor unit with one or more processors and computer readable medium (CRM), such as random access memory and/or read only memory. Server 120A includes processor unit 160A and CRM 162A, and server 120M includes processor unit 160M and CRM 162M. The processing unit communicates with the CRM to execute operations and tasks that implement or assist in implementing example embodiments. One or more of the servers can also include a user profile, such server 120M including a user profile 168.

The electronic devices 110A to 110N include a processor unit with one or more processors and computer readable medium (CRM), such as random access memory and/or read only memory. Electronic device 110A includes processor unit 170A and CRM 172A, and electronic device 110N includes processor unit 170N and CRM 172N. The processing unit communicates with the CRM to execute operations and tasks that implement or assist in implementing example embodiments. One or more of the electronic devices can also include a user profile, such as electronic device 110A including a user profile 178.

By way of example, the electronic devices 110A to 110N include, but are not limited to, handheld portable electronic devices (HPEDs), wearable electronic devices, portable electronic devices, computing devices, electronic devices with cellular or mobile phone capabilities, digital cameras, desktop computers, servers, portable computers (such as tablet and notebook computers), handheld audio playing devices (example, handheld devices for downloading and playing music and videos), personal digital assistants (PDAs), combinations of these devices, and other portable and non-portable electronic devices and systems.

By way of example, the networks 150 can include one or more of the internet, an intranet, an extranet, a cellular network, a local area network (LAN), a home area network (HAN), metropolitan area network (MAN), a wide area network (WAN), public and private networks, etc.

By way of example, the storage 130 can include various types of storage that include, but are not limited to magnetic storage and optical storage, such as hard disks, magnetic tape, disk cartridges, universal serial bus (USB) flash memory, compact disk read-only memory (CD-ROM), digital video disk read-only memory (DVD-ROM), CD-recordable memory, CD-rewritable memory, photoCD, and web-based storage. Storage can include storage pools that are hosted by third parties, such as an operator of a data center. The electronic devices and/or servers can use the storage to store files, software applications, data objects, and other information (such as advertisements). Storage can be accessed through a web service application programming interface, a web-based user interface, or other mechanisms.

By way of example, the advertising 140 includes advertising agents and/or agencies, advertising brokers, ad servers, websites, retailers, manufacturers, and other entities that have, manage, and/or store advertisements for products.

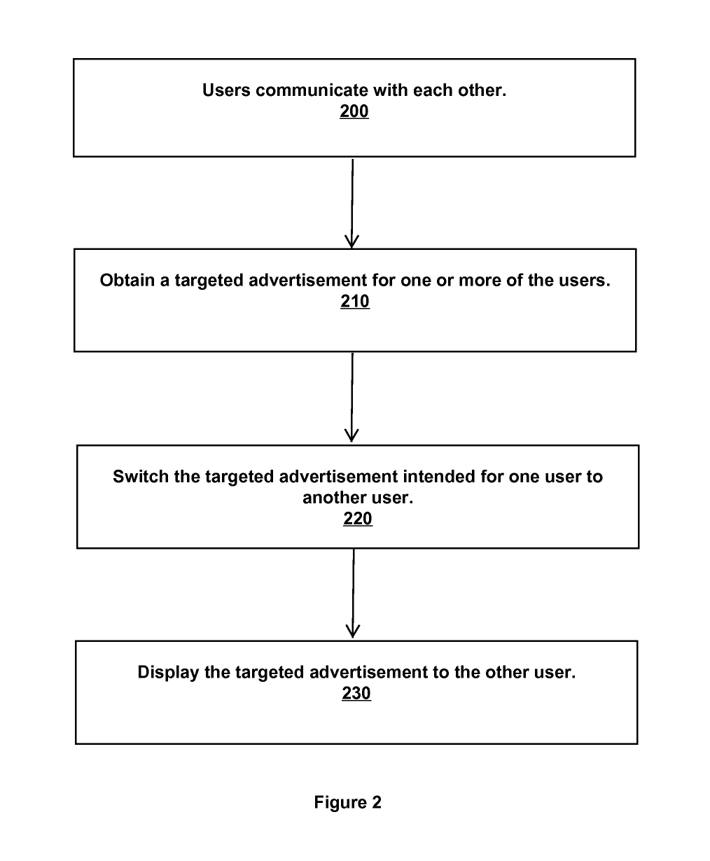

FIG. 2 is a method to switch targeted advertisements between users.

Block 200 states users communicate with each other.

Two or more users begin to communicate with each other over one or more electronic devices and/or media, such as storage and transmission channels and/or software programs used to store and/or deliver information. Some examples include, but are not limited to, electronic devices (including HPEDs such as tablet computers, personal computers, and smartphones), e-mail, social networks, Voice-over Internet Protocol (VoIP) services, Short Message Service (SMS), a network (such as a cellular services and/or the Internet), and a mobile application or mobile app.

Block 210 states obtain a targeted advertisement for one or more of the users.

One or more targeted advertisements are retrieved, obtained, selected, received, transmitted, sent, and/or stored. These targeted advertisements can come from or originate from storage, a website, an advertiser, an ad server, an advertising agency, a manufacturer, a retailer, a company, or an organization.

A determination of which targeted advertisement to obtain for a user can come from and/or be based on personal information, personal preferences, personal traits, and/or information in a user profile. By way of example, a user profile includes personal information associated with a specific user, such as including characteristics, preferences, and/or habits of the user. An electronic device and/or a user agent then use the user profile to determine what targeted advertisements are retrieved and displayed to the user.

In order to build the user profile, one or more electronic devices monitor and collect data with respect to the user and/or electronic devices, such as electronic devices that assist the user in communicating over networks and electronic devices that the user owns and/or interacts. By way of example, this data includes user behavior on an electronic device, installed client hardware, installed client software, locally stored client files, information obtained or generated from a user's interaction with a network (such as web pages on the internet), email, peripheral devices, servers, other electronic devices, programs that are executing, etc. The electronic devices collect user behavior on or with respect to an electronic device (such as the user's computer), information about the user, information about the user's computer, and/or information about the computer's and/or user's interaction with the network.

By way of example, a user profile builder monitors user activities and collects information used to create a user profile. The profile builder monitors the user's interactions with one or more electronic devices, the user's interactions with other software applications executing on electronic devices, activities performed by the user on external or peripheral electronic devices, etc. The profile builder collects both content information and context information for the monitored user activities and then stores this information. By way of further illustration, the content information includes contents of web pages accessed by the user, graphical information, audio/video information, uniform resource locators (URLs) visited, searches or queries performed by the user, items purchased over the internet, advertisements viewed or clicked, information on commercial or financial transactions, videos watched, music played, interactions between the user and a user interface of an electronic device, commands (such as voice and typed commands), hyperlinks clicked or selected, etc.

The user profile builder also gathers and stores information related to the context in which the user performed activities associated with an electronic device. By way of example, such context information includes, but is not limited to, an order in which the user accessed web pages (user's browser navigation), a frequency or number of times a user navigated to a web location, information regarding the user's response to interactive advertisements and solicitations, information about a length of time spent by the user on the web pages, information on the time when the user accessed the web pages, etc.

As previously stated, the user profile builder also collects content and context information associated with the user interactions with various different applications executing on one or more electronic devices. For example, the user profile builder monitors and gathers data on the user's interactions with a web browser, an electronic mail (email) application, a word processor application, a spreadsheet application, a database application, a cloud software application, and/or any other software application executing on an electronic device.

By way of illustration, the user profile builder collects content information for emails that include one or more of the recipient information, sender information, email subject title information, and the information related to the contents of the email including attachments. Context information for an email application may include the time when the user receives emails, time when the user sends emails, subject matter of the emails, frequency of the emails, recipients, etc.

Based on the user profile, a determination is made of products that the user expressed an interest in purchasing and/or might intend to purchase and/or would be interested in receiving information. Information in the user profile is examined to determine one or more products that the user may desire and/or may intend to purchase at a current time and/or at a time in the future. An analysis of one or more pieces of information included in the user profile occurs in order to make an intelligent prediction of products and/or services that the user desires to purchase at a current or future time.

As one example, this determination can include keywords extracted from information entered into a handheld portable electronic device (HPED). By way of example, such information includes, but is not limited to, user generated information such as a text, an email, a voicemail, and/or a voice exchange with another person. For instance, a user may state in an email or text certain keywords or phrases that indicate the user desires, needs, wants, and/or intends to purchase a product and/or service (such as “I want . . . ” or “I would like to have . . . ” or “I need . . . ” or “For my birthday . . . ” or “I saw a really nice . . . ” etc). As another example, this determination can include information extracted from a personal electronic device owned by the user. For instance, software and/or hardware on a tablet or personal computer of the user can be out-of-date or new software available, such as new software games or other software the user is interested in purchasing. For instance, the user may be interested in purchasing a new laptop computer, a new smart phone, or a new tablet computer. As yet another example, this determination can include information extracted from a previous purchase of the user. For instance, if the user purchases a vehicle (such as a motorcycle, a car, a boat, etc.), the user may be interested in also purchasing an ancillary product for the vehicle. Alternatively, if the user purchases product X, then the user may also be interested in product Y since other customers that purchased product X also purchased product Y. As yet another example, this determination can include information based on a current, previous, or future physical geographical location of the user. For instance, if the user plans a camping trip to a national forest, the user may be interested in purchasing camping and/or sporting gear. Alternatively, the user may have visited a specific type of store, such as one specializing in particular product and/or service. As yet a further example, this determination can include information from websites that the user visited. For instance, if the user visits a website that sells printers or performs a web query about different printers to purchase, the user may be interested in purchasing a new printer. As yet another example, this determination includes information of the user's prior interest or activity in certain sports, travel destinations, clothes or objects previously purchased, or entertainment preferences. As yet another example, this determination is based on an age of goods or objects that the user owns or previously purchased, such as owning an electronic device that is outdated.

Block 220 states switch the targeted advertisement intended for one user to another user.

Targeted advertisements can be switched in a variety of ways. Some examples are provided herein.

As one example of switching targeted advertisements, a targeted advertisement intended for a first user is sent to the first user and to a second user for whom the targeted advertisement is not intended. For instance, a user profile of a user indicates that the user would be interested in purchasing a smartphone. An advertisement for a smartphone is sent to the user and to another user. This other user is a friend of the user, but does not have an interest in purchasing a smartphone.

As another example of switching targeted advertisements, a targeted advertisement intended for a first user is not sent to the first user, but sent to a second user for whom the targeted advertisement is not intended. For instance, a purchase history of a user indicates that the user is a candidate to purchase movie tickets. A targeted video advertisement for a movie is sent to another user who is a business associate of the user. This business associate is not known to be a candidate to purchase movie tickets. The targeted advertisement is displayed on an electronic to the business associate of the user while the business associate uses the electronic device to communicate with the user over a social network.

As another example of switching targeted advertisements, a targeted advertisement intended for a first user is sent to a second user for whom the targeted advertisement is not intended, and a targeted advertisement intended for the second user is sent to the first user for whom the targeted advertisement is not intended. Neither the first nor second users see the targeted advertisement intended for them. For instance, a determination is made that a first user is likely to purchase an automobile in the near future, and a determination is made that a second user is likely to purchase a cruise vacation. A targeted video advertisement for an automobile (which is directed and intended for the first user) is played for the second user, while a targeted video advertisement for a cruise vacation (which is directed and intended for the second user) is played for the first user. The advertisement for the automobile is not shown to the first user, and the advertisement for the cruise vacation is not shown to the second user. The video advertisements are played to the users while they communicate with each other over a network.

As another example of switching targeting advertisements, a user purchases a mobile application that enables other users or other members with the mobile application to exchange advertisements with each other. The user finds celebrities that are also using the mobile application and selects these celebrities to follow. When one of the selected celebrities views an advertisement on his or her HPED, the advertisement is simultaneously displayed to the user. As such, the user knows when the celebrity is viewing an advertisement and can view the advertisement at the same time as the celebrity. If the celebrity were to stop viewing the advertisement, then the advertisement would stop playing on the HPED of the user.

Block 230 states display the targeted advertisement to the other user.

The targeted advertisement can be displayed, presented, transmitted, stored, and/or sent to the other user. By way of example, the advertisement is presented on a display of an electronic device of the user, such as displaying a video ad, a banner ad, an e-mail ad, an audio ad, text ad, a poster or graphics ad, a floating ad, an expanding ad, a wallpaper ad, a trick banner, a pop-up ad, a pop-under ad, a map ad, a mobile ad, a three-dimensional (3D) ad, an interstitial ad, a frame ad, a display ad, etc.

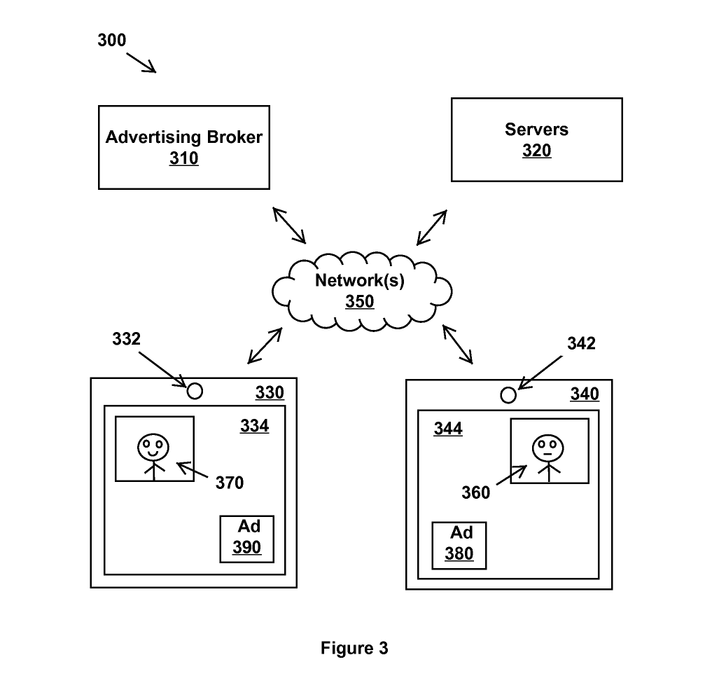

FIG. 3 is a computer system in which electronic devices switch and/or follow advertisements. The computer system 300 includes an advertising broker 310 or other entity that manages and/or stores advertisements, one or more servers 320, electronic devices 330 and 340, and one or more networks 350 through which the elements communicate.

Electronic device 330 includes a camera 332 and a display 334, and electronic device 340 includes a camera 342 and a display 344. These two electronic devices are engaged in a video call such that an image of a first user 360 (i.e., the user of the electronic device 330) appears on the display 344 of electronic device 340, and an image of a second user 370 (i.e., the user of the electronic device 340) appears on the display 334 of electronic device 330. During the video call, a targeted advertisement 380 directed to the first user 360 appears on the display 344 of electronic device 340 (i.e., on the display of the second user), while a targeted advertisement 390 directed to the second user 370 appears on the display 334 of electronic device 330 (i.e., on the display of the first user). As such, the targeted advertisements are switched such that the first user sees the targeted advertisement intended for the second user, and the second user sees the targeted advertisement intended for the first user.

The advertising broker or an ad server 310 stores, manages, generates, and/or retrieves targeted advertisements directed to specific products, specific users, groups of users, etc. These targeted advertisements are retrieved and directed to a target recipient. For example, an analysis of a user profile of the first user determines that the first user is a target candidate to purchase a kitchen appliance, and an analysis of the user profile of the second user determines that the second user is a target candidate to purchase farm equipment. Advertisements directed to farm equipment and kitchen appliances are retrieved from the advertising broker 310. A request for such advertisements can originate from the electronic devices 330 and 340, software applications (such as an application executing on the electronic devices), or the servers 320 (such as a website or social network to which both the first and second users are logged into and/or members).

Example embodiments include targeted and non-targeted advertisements. Furthermore, the targeted advertisements can be based on public information, private information, semi-private (information having some degree of privacy but not fully private), and semi-public (available to a portion, but not all, of the public).

Advertisements between users can be switched and/or followed without disclosing private information of the users. For example, advertisements between users are switched such that a first user sees an advertisement based on private information of a second user, and the second user sees an advertisement based on private information of the first user. The advertisements are switched while privacy of the information is maintained.

Consider an example in which private information of a first user is analyzed to determine that the first user intends to purchase a smartphone in the next few months. Private information of a second user is analyzed to determine that the second user intends to purchase tennis shoes. The first and second users communicate with each other with a software program that uses VoIP (such as SKYPE). During this video call, advertisements are displayed to the users on screens of their electronic devices. While the users are talking to each other, an advertisement for the tennis shoes plays on the display of the electronic device of the first user while simultaneously an advertisement for the smartphone plays on the display of the electronic device of the second user. The first user does not see the advertisement for the smartphone, and the second user does not see the advertisement for the tennis shoes. Thus, the advertisements are switched such that the first user sees the advertisement of the second user, and the second user sees the advertisement of the first user.

Target advertising is a type of advertising in which advertisements are provided to users based on a certain trait or activity of the user, such as demographics, purchase history, user preferences, user profile, tracking online or mobile web activities (such as websites visited, web searches performed, hyperlinks clicked), user interface (UI) actions, etc. For example, if a user visits websites that sell automobiles, then an assumption is made that this user is interested in automobiles. Thereafter, the user is targeted to receive advertisements related to automobiles. Targeting advertisement is effective since the targeted user is more likely to have an interest in the product when compared with a non-interested, non-targeted, or random user.

An example embodiment switches targeted advertisements between users and/or displays targeted advertisements intended for one user to another user for whom the targeted advertisement is not intended. For example, a targeted advertisement directed to a first user is sent to a second user, and a target advertisement directed to the second user is sent to the first user. As another example, a targeted advertisement directed to a first user is sent to the first user and a plurality of other users that are interested in the first user but may or may not have shown a predisposition to purchasing the product to which the advertisement is targeted. This switching is contrary to a benefit of traditional targeting advertisement (i.e., that advertising is more effective when advertisements are provided or displayed to a user that has a preference for the product in the advertisement). Switching the targeted advertisements, however, has benefits not present with traditional targeted advertising.

When the targeted advertisements are switched, an increased probability exists that one of the users will comment to the other user on the targeted advertisement. Consider an example in which a mother and her son are having a video call over the Internet on their respective HPEDs. During the video call, the HPED of the son displays a video advertisement for a sewing machine model PDQ (which is a targeted advertisement for his mother). This advertisement displays to the son, but not to the mother. The son sees the advertisement for the sewing machine, and this advertisement reminds him that his mother likes to sew. In response to this advertisement and reminder, the son makes a comment to his mother. Consider a hypothetical conversation as follows:
Son: “Mom, how are your sewing projects going?”
Mom: “Great son. Why do you ask?”
Son: “I just saw this ad for sewing machine PDQ and it made me think about your sewing.”

In this hypothetical, the advertisement worked to remind the son of his mother's sewing and to alter the conversation between the mother and her son. The advertisement was highly effective on both the mother and her son. The mother may not have previously known about the sewing machine PDQ, or this comment may entice her to further investigate this machine or even purchase this machine. Additionally, the son may consider buying this sewing machine as a gift for his mother.

Consider another example in which two friends (named Ben and Jerry) are texting each other with their respective HPEDs. During the text exchange, the HPED of Ben displays a video advertisement for mountain biking (which is a targeted advertisement for Jerry). This advertisement displays on the HPED of the Ben, but not on the HPED of the Jerry. Ben pays little attention to the video since he is not interested in mountain biking, but he does notice men riding mountain bikes in the advertisement. This causes Ben to remember that Jerry previously mentioned something about an upcoming mountain biking trip. Consider a hypothetical conversation as follows:
Ben: “So, what about your biking trip? Are you still planning to go?”
Jerry: “Yes, the boys and I are going next month.”
Ben: “Okay, have fun.”

In this hypothetical, the advertisement worked to remind Ben about Jerry's upcoming mountain biking trip. This reminder causes Ben to alter his current conversation with Jerry. Although Ben does not explicitly mention the advertisement or that he viewed the advertisement, it was highly effective. In response to the advertisement and conversation, Ben may now be more likely to purchase a mountain biking product. For instance, Ben may think about becoming more active in mountain biking, especially since his friend Jerry is interested in mountain biking. The conversation also reminded Jerry about his upcoming trip, and this reminder may entice him or remind him to purchase a mountain biking product.

Consider another example in which John is a member of a social network such as TWITTER or FACEBOOK), and John's friends or followers include three people named Sue, Anna, and Jeff. Private information about John indicates that he may purchase a HPED model JKL. Based on this information, Sue, Anna, and Jeff are sent promotions and/or advertisements to purchase the HPED model JKL. Sue and Anna disregard the promotions and/or advertisements, but Jeff responds and visits a retail store that sells the HPED model JKL. Jeff posts a picture and a message in the social network stating that he is at the retail store to view the new HPED model JKL (e.g., Jeff uploads a picture of himself in the store while standing next to the HPEDs). John views this picture and message, and it reminds him of his own desire to purchase the HPED model JKL. John, now knowing that his friend Jeff is interested in buying an HPED model JKL, proceeds to purchase this HPED.

In this hypothetical, switching the advertisement was highly effective since it caused Jeff to go to a retail store and investigate the HPED. Jeff then mentioned his location on the social network, and this caused John to increase his already existing interest in the HPED and then purchase the HPED.

When targeted advertisements are switched or sent to other users, an increased probability exists that one of the users will purchase the product based on an association or common interest with the intended target recipient. Consider an example in which followers of a celebrity receive and view targeted advertisements directed to and intended for the celebrity. Some of these users will purchase the advertised product since the celebrity is interested in the product, endorses the product, and/or views the targeted advertisement for the product. This targeted advertisement also provides a glimpse or insight into a personal interest of the celebrity, and this glimpse may be sufficient to entice some users to then purchase the advertised product even though they would not have otherwise made the purchase.

Thus, switching targeted advertisements can be an effective method to advertise to individuals to whom the targeted advertisement is not designed and intended. Instead of showing the targeted advertisement to an intended target individual (i.e., the person for whom the advertisement is targeted), the advertisement is instead shown to a non-targeted individual that has an association, common interest, or relationship with the target individual. Alternatively, the targeted advertisement is shown to both the targeted individual and non-targeted individuals.

In an example embodiment, the individuals or group of people have a common interest and/or an association. For instance, the individuals are friends with each other, have a familial relationship (e.g., brothers, sisters, husband, wife, son, daughter, cousin, grandparent, etc.), execute a common software application, own a common make or model HPED, have a professional relationship (e.g., co-workers or employees of a same company), belong to or are members of a same social network (e.g., are friends or acquaintances on FACEBOOK, TWITTER, LINKEDLN, PINTEREST, GOOGLE PLUS, or MYSPACE). Furthermore, one or more of the users or individuals can be a celebrity, an actor, a musician, an athlete, famous, an admired person, or a person of importance. Since the individuals or groups know each other and/or have a common interest, they are more likely to view a product advertisement intended for another individual and then purchased the product and/or effect this other individual to purchase the product in the advertisement.

Targeted advertisements are switched without revealing private information to the users. Consider an example in which private information of a first user is analyzed to predict a product that the first user has a high likelihood of buying. A targeted advertisement for this product is selected and then displayed not to the first user but to a second user who is a business associate of the first user. In an example embodiment, the second user is not informed that the advertisement is actually a targeted advertisement for another person (i.e., the first user). Thus, the second user does not know this fact. Alternatively, the second user can be informed that the advertisement is a targeted advertisement for another person. For example, a message displays at the beginning and/or end of the advertisement stating that it is an advertisement for the first user. For instance, if a name of the first user is John Smith, then a message displays during the advertisement stating this fact (such as a message stating: “Ad for John Smith”).

Targeted advertisements can be presented to users based on the users association with another person, as opposed to their likelihood or propensity to buy the advertised product based on their own, personal preferences. As such, private information and/or a user profile of the second user provides no indication that this second user has an interest in the product. In other words, the second user would not otherwise be a recipient of this targeted advertisement but for the fact that the second user has a common interest or association with the first user.

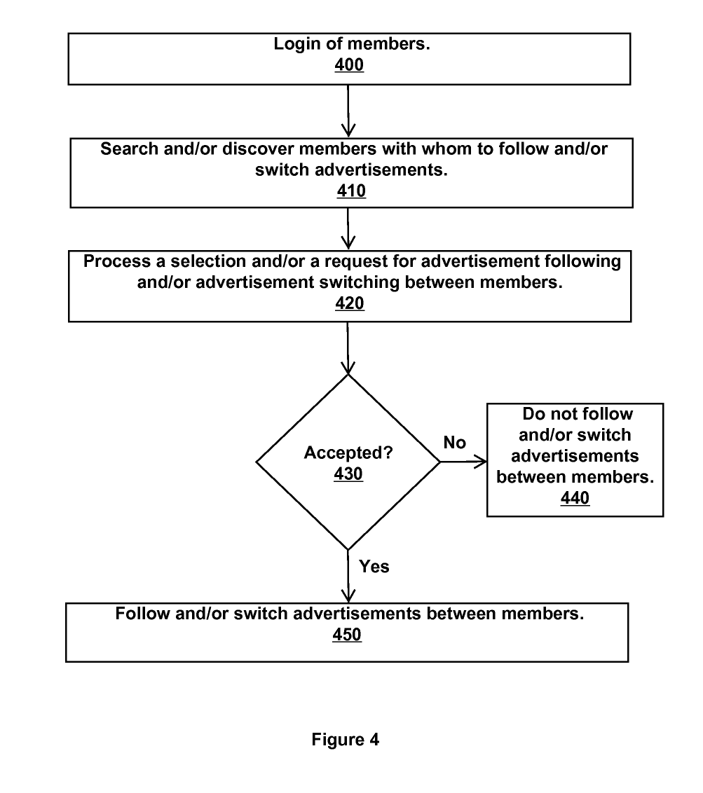

FIG. 4 is a method to follow and/or switch targeted advertisements among users.

Block 400 states login of members.

By way of example, members, users, electronic devices, and/or software applications can login with a unique identification to a network, a website (such as a social network), an electronic device (such as an HPED), and/or a software application (such as a mobile application on an HPED). Further, login can occur a single time (such as a user providing personal information and/or a username to activate a software program). Alternatively, login can occur numerous times (such as a user providing login credentials each time the user navigates to a website). Users can also be members without providing a username and password (such as using biometrics or other identifying indicia). Further yet, login can occur when a user navigates to a website (such as a user being automatically logged into his social networking website when his HPED navigates to this website).

Block 410 states search and/or discover members with whom to follow and/or switch advertisements.

Members within a group or organization can be searched and discovered by other members, users, electronic devices, and/or software applications. For example, members of a social network that participate in advertisement switching or advertisement following can be discovered by other members that also participate in the advertisement switching or advertisement following. As another example, users or members that run a same software application (such as an application that executes example embodiments) can search and discover each other.

Block 420 states process a selection and/or a request for advertisement following and/or advertisement switching between members.

Members, users, electronic devices, and/or software applications can search, discover, view, and select other members with whom to switch and/or follow advertisements. For example, a first user of a social network can send a second user of the social network an advertisement switching request. This request asks whether the second user is willing to switch advertisements with the first user. As another example, a first member of a mobile application sends another member of the mobile application an advertisement following request. This request asks the second member whether the first member can follow and receive targeted advertisements that are directed to the second member.

Block 430 makes a determination as to whether to accept the selection and/or request among members to participate in advertisement switching and/or advertisement following. If the answer to this determination is “no” then flow proceeds to block 440 that states do not follow and/or switch advertisements between members (e.g., deny the selection and/or request among members to participate in advertisement switching and/or advertisement following). If the answer to this determination is “yes” then flow proceeds to block 450 that states follow and/or switch advertisements between members (e.g., accept the selection and/or request among members to participate in advertisement switching and/or advertisement following).

Consider an example in which a user downloads a mobile application to his HPED that enables the user to participate in advertisement following. In order to activate an account with this mobile application and become a member, the user provides an email address, name, username, password, and/or an identifying input. Thereafter, the user (now a member of the mobile application) searches for famous actors and sports figures that are also members of the advertisement following application. A list of actors and sports figures appears on a display of the HPED, and the user selects several of these actors and sports figures to initiate a request to follow advertisements. These requests are automatically granted, and the user is added to a list of recipients or followers of the selected actors and sports figures. Thereafter, when a targeted advertisement is sent to or viewed by one these selected actors and sports figures, the user is notified of this action. The user can also view the same advertisement in real-time while the selected actors or sports figure also views the advertisement.

Consider an example in which a user (named John) is a member of the social network FACEBOOK. The user logins into this social network and sends a friend (named Alice) an advertising switching request that will endure one week or another amount of time selected by John. This request essentially asks the following question: “Alice, would you like to switch advertisements for one week with your friend John?” If Alice accepts the request, then for the next week, targeted advertisements directed to and intended for John are displayed to Alice, while targeted advertisements directed to and intended for Alice are displayed to John. In addition to viewing the switched advertisements, John and Alice can take other actions on one or more of the advertisements, such as rating the advertisements, forwarding the advertisements to members or friends in the social network, purchasing a product advertised in the advertisement (such as Alice viewing a targeted advertisement for a watch and then purchasing the watch for John), commenting about the advertisements to the intended recipient, indicating a like or dislike for the advertisements, inferring a gift idea from an advertisement for the intended recipient, and saving or deleting the advertisements.

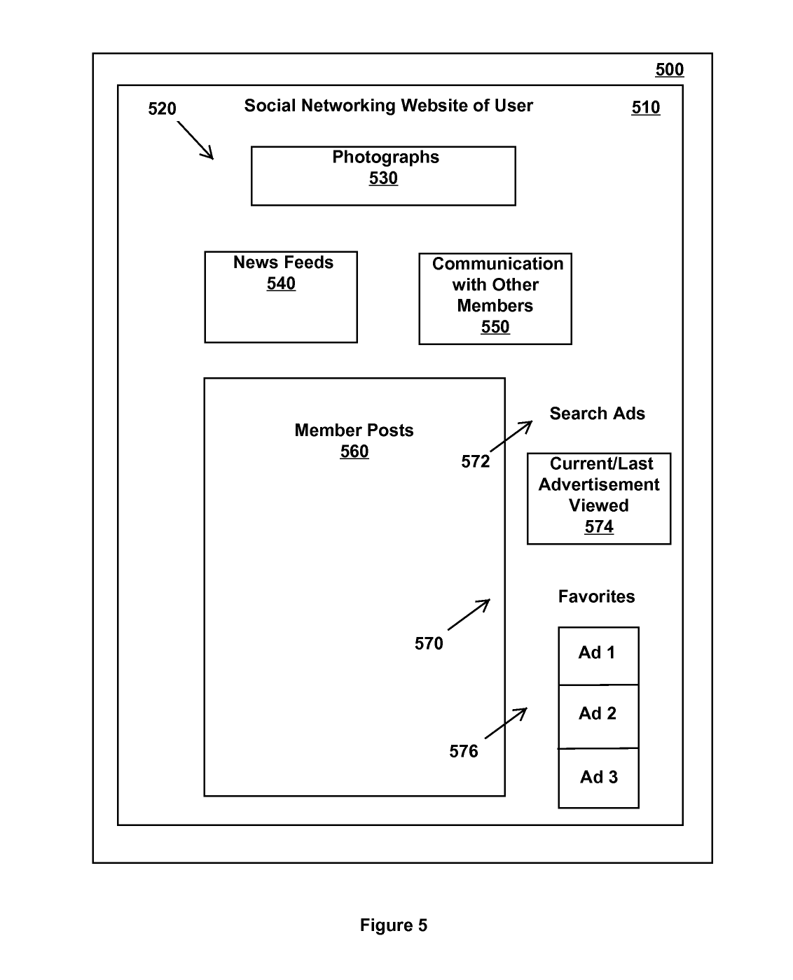

FIG. 5 is an electronic device 500 with a display 510 that shows a social networking website 520 of a user that switches and/or follows advertisements with another user.

By way of example, the social network website 520 of the user includes one or more of photographs 530 (such as photos uploaded by the user and/or received from other members), news feeds or web feeds 540, communications with other members 550 (such as a tool or software program that enables a user to chat, SMS, video, and/or contact another individual), member posts 560, and advertisements followed and/or switched with another user 570. These advertisements 570 include a link or tool to search the advertisements 572, a window, box, or area that displays a current or last advertisement viewed 574, and favorite advertisements 576.

Consider an example in which the social networking website 520 belongs to a user named Paul. Paul and his friend (named Sarah) decide to allow Paul to follow advertisements directed to Sarah. Thus, window 574 shows a current or last viewed advertisement of Sarah. In other words, this window shows that last advertisement that Sarah viewed on her electronic device. As such, Paul can track advertisements that Sarah is currently viewing on her electronic device.

Consider an example in which Sarah plays or views a targeted advertisement intended and directed to her on her electronic device and/or at her social networking website. This targeted advertisement is simultaneously sent to and displayed at the social network website 520 of Paul in area 574. As such, Paul can view an advertisement intended for Sarah at a same time that Sarah also views the advertisement. The advertisement on the display of Paul starts at a same time as the advertisement starts on the display of Sarah. Paul knows that Sarah is currently viewing this advertisement since it plays in area 574. If Sarah were to stop or quit viewing the advertisement on her electronic device, then the advertisement would also stop playing in area 574 on the electronic device of Paul. For example, Sarah may look away from the advertisement, ignore the advertisement, or delete the advertisement while it is playing.

Consider another example in which Sarah views an advertisement while Paul is offline and/or not logged into his social networking website 520. When Paul logs into the social networking website 520, the last viewed advertisement of Sarah displays in area 574. Paul can click or activate the advertisement to view it and/or get more information (such as a data and time when Sarah viewed the advertisement).

The second box or area 576 on the display 510 shows a series of other advertisements Sarah viewed. As such, Paul can track advertisements that Sarah previously viewed. These advertisements are arranged as video thumbnails in a hierarchy from a top advertisement (shown as Ad 1) to a bottom advertisement (shown as Ad 3). The advertisements in this hierarchy can be arranged according to different hierarchical schemes, such as arranging the advertisements according to Paul's favorites (a more favored ad appearing in the location of Ad 1 and a lesser favored ad appearing in the location of Ad 3), Sarah's favorites, other users' favorites (ranking the advertisements based on input from friends of Paul, friends of Sarah, and/or members in the social network), likes and/or dislikes, a number of views, effectiveness, ratings from members, etc. Furthermore, an order of the advertisements in the hierarchy can periodically, intermittently, or continually change. For instance, the order is reshuffled or changed based on likes and dislikes from other members or based on a number of views (e.g., as more users view one of Sarah's ads, this ad moves up in the hierarchy).

Area 576 can also include advertisements of other users. Consider an example in which Paul follows the advertisements of other users besides Sarah. Paul can thus simultaneously follow advertisements of multiple users and have their targeted advertisements appear on his social networking website.

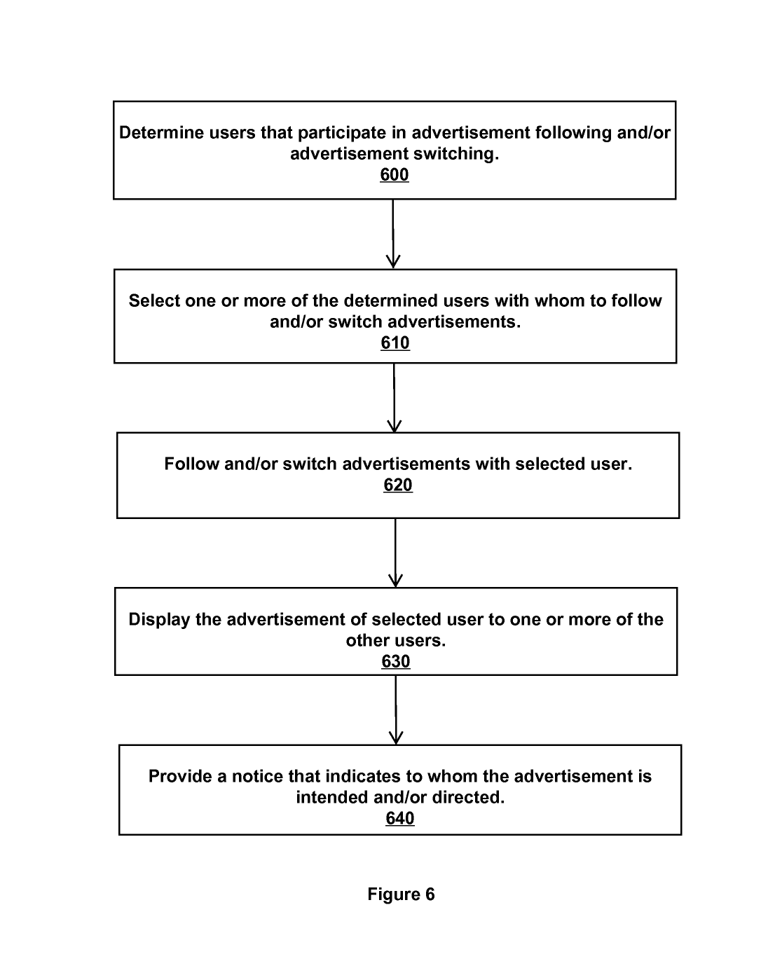

FIG. 6 is a method to follow and/or switch advertisements among users.

Block 600 states determine users that participate in advertisement following and/or advertisement switching.

By way of example, a user, an electronic device, or a software application can search, obtain, receive, and/or retrieve other users that agree to follow, share, and/or switch advertisements with each other. Names of discovered users are displayed and/or provided to the searcher.

Block 610 states select one or more the determined users with whom to follow and/or switch advertisements.

By way of example, one or more of the discovered users are selected for advertisement following and/or advertisement switching.

Block 620 states follow and/or switch advertisements with the selected user.

By way of example, users are able to view advertisements intended for and directed to other users. Additionally, other information can be provided to the users, such as a date and/or time when the advertisement was viewed, an emotional reaction to the advertisement, whether the user liked or disliked the advertisement, a geographical location where the advertisement was viewed, whether the user bought the advertised product, whether the advertisement was effective (e.g., whether the user clicked the ad or followed a hyperlink), whether the user actually viewed the advertisement, whether the user saved or deleted or ignored the advertisement, a type of electronic device on which the user viewed the advertisement, and whether the user shared the advertisement with another individual.

Block 630 states display the advertisement of the selected user to one or more of the other users.

By way of example, the advertisement is transmitted over a network to a user and/or electronic device, stored in memory, displayed to a user, provided to the user, provided to a software application, provided to an electronic device, and/or provided to a third party.

Block 640 states provide a notice that indicates to whom the advertisement was intended and/or directed.

By way of example, the notice provides visual and/or audible information so a user can determine to whom the advertisement was intended or directed. This notice can be transmitted and/or included with or without the advertisement. For example, a written message included on the advertisement or near the advertisement indicates the information.

Consider an example in which John follows advertisements that Sarah views. An advertisement intended for Sarah appears on a display of an HPED of John, and a message states: “Sarah's ad.” This message indicates that the advertisement is targeted to Sarah and/or that the advertisement is intended for Sarah. This message could appear at the beginning of the ad, at the end of the ad, overlaid on the ad while the ad plays, etc. As another example, the advertisement includes a border that indicates the information.

Consider an example in which John and Sarah switch advertisements such that Johns sees Sarah's ads and Sarah sees John's ads. When an advertisement for Sarah appears on John's display, the advertisement has blue border that indicates an ad for Sarah. As another example, the advertisement for Sarah appears as a distinguishable icon, or an indication of ownership appears in a visually distinguishable frame or perimeter. The icon or perimeter provides visual indicia so the user can associate the advertisement with a specific person and/or a specific software application.

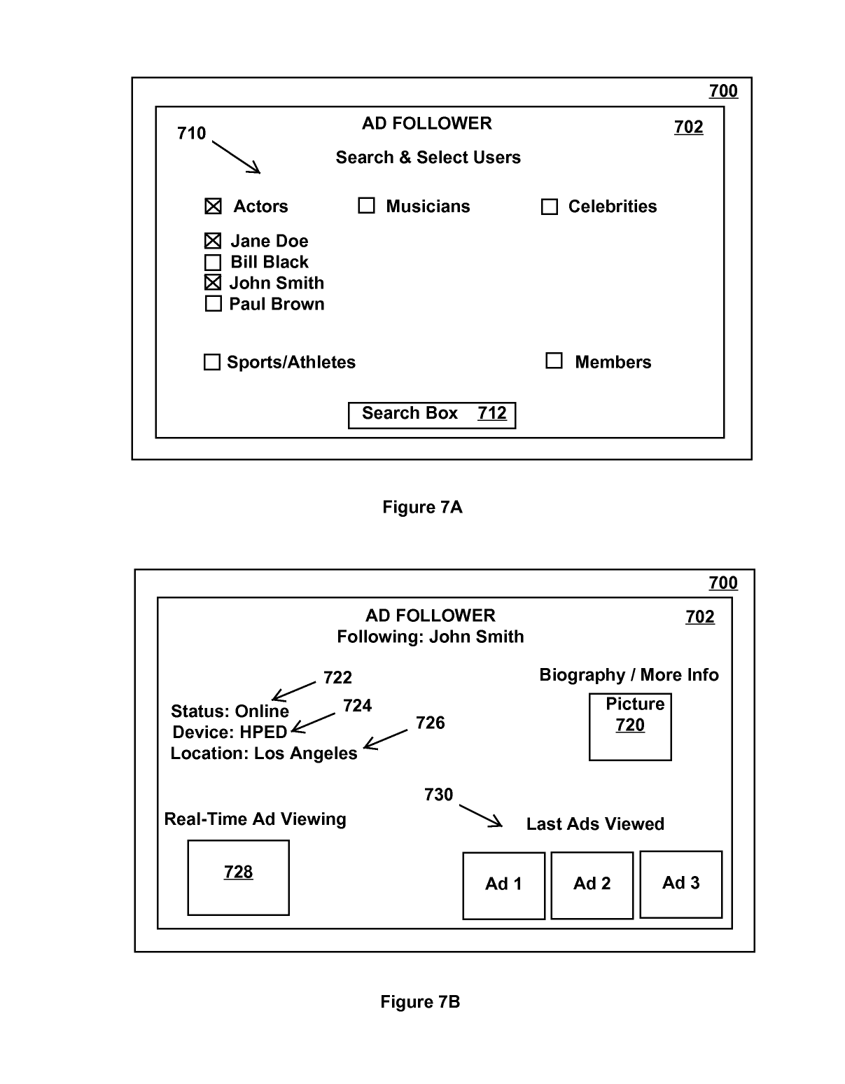

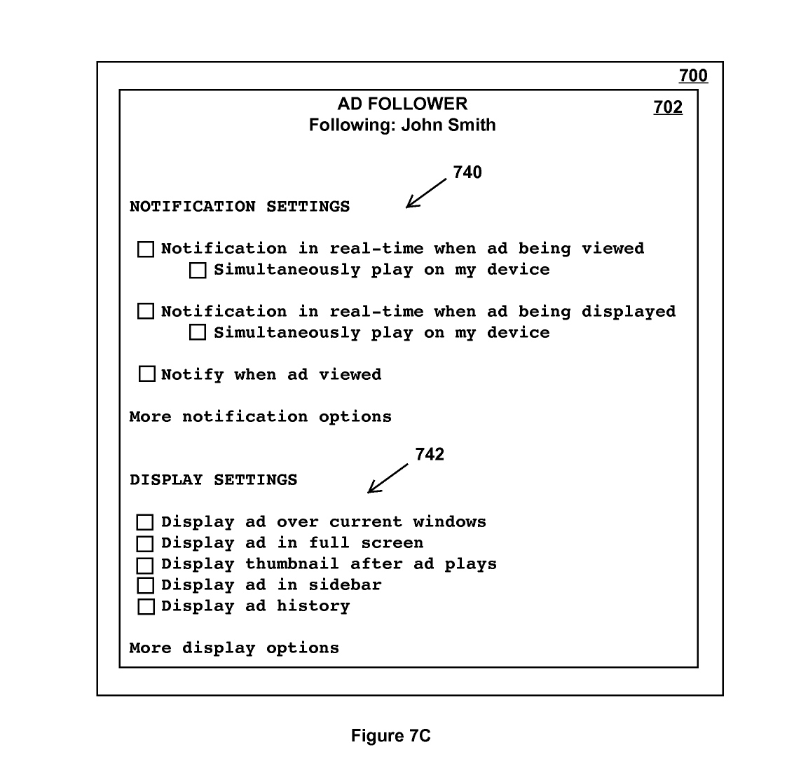

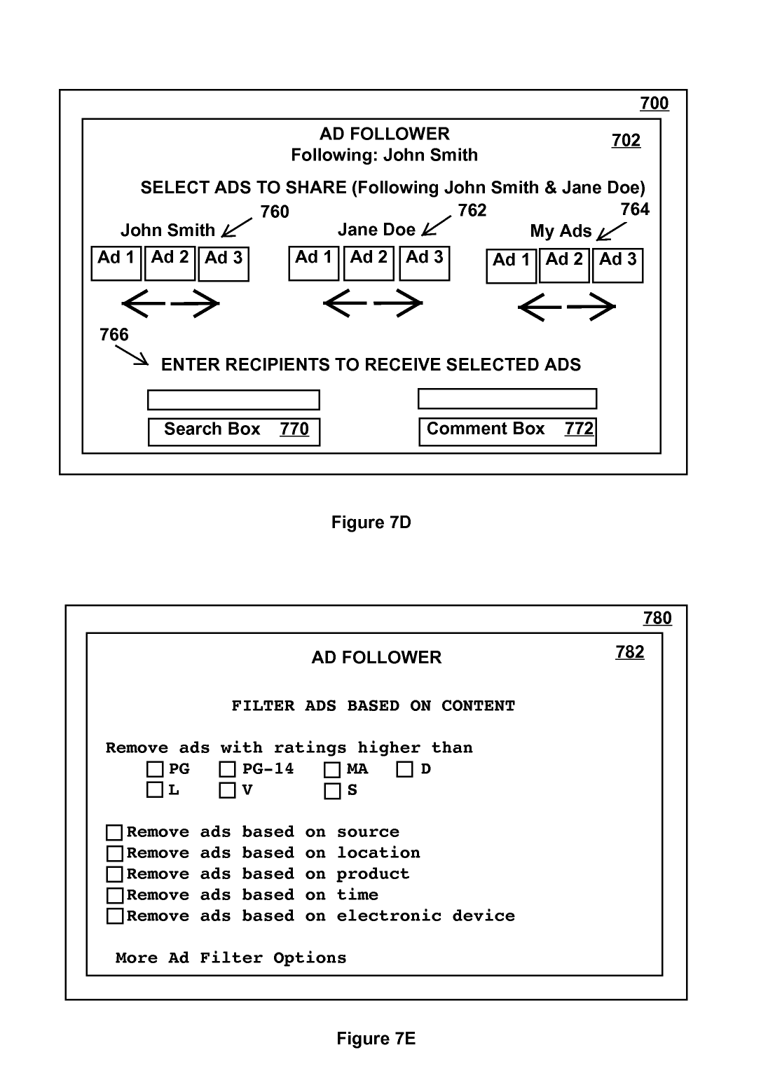

FIGS. 7A-7E show electronic devices that display different information for advertisement following and/or advertisement switching. For example, this information can be presented at a website and/or form part of a software application (such as a mobile application that executes on HPEDs or other electronic devices).

FIG. 7A is an electronic device 700 with a display 702 that shows searching and selecting individuals for advertisement following and/or advertisement switching. The display 702 shows a list of categories 710 of users (shown as Actors, Musicians, Celebrities, Sports/Athletes, and Members) that participate in advertisement following and/or advertisement switching. A search box 712 enables a user to search for a specific user (such as searching by name, username, email, keywords, etc.). For illustration, a selection is made to follow advertisements of two movie actors (an actress named Jane Doe and an actor named John Smith) since these boxes are marked. When these boxes are subsequently unselected, then the user discontinues to follow the selected user. Targeted advertisements intended for the selected user would thus discontinue being transmitted to the user.

FIG. 7B is the electronic device 700 with the display 702 that shows additional information about one of the selected users being followed. For illustration, more information is shown about actor John Smith. For example, a user clicks on the name “John Smith” to find out more information regarding advertisement following and/or switching with regard to John Smith.

As shown in FIG. 7B, the additional information about John Smith includes a picture and/or biography 720, a status 722 (e.g., indicating whether John Smith is online and/or available for ad following), a device 724 (e.g., indicating which type of electronic device John Smith is using to view advertisements), a location 726 (e.g., a Global Positioning System (GPS) location of John Smith), a real-time ad viewing window 728 (e.g., showing an advertisement that John Smith is currently viewing in real-time on his HPED), last-ads-viewed windows 730 (e.g., showing a list of which ads John Smith previously viewed on his HPED, such as Ad 1, Ad 2, and Ad 3 such that these ads can be tracked).

FIG. 7C is the electronic device 700 with the display 702 that shows advertisement notifications settings and/or options 740 and advertisement display settings and/or options 742.

The notification settings enable a user to determine how the user is notified when the selected user (e.g., John Smith) views an advertisement. For illustration, some example notification options include notify the user in real-time when the selected user views an ad, simultaneously display the ad of the selected user on the display of the user, notify the user in real-time when an ad is being displayed to the selected user (e.g., the ad is being displayed but not yet viewed or already viewed), simultaneously display the ad being displayed to the selected user on the display of the user, provide a notice to the user when the selected user views an advertisement (e.g., provide a text message, email, or other notification).

The advertisement display settings and/or options 742 provide the user with options on how to view the advertisement being viewed by or displayed to the selected user. For illustration, some example display options include display the ad over current windows on the electronic device of the user, display the ad in full screen on the electronic device of the user, display the ad in a sidebar or perimeter on the electronic device of the user, display ad histories or previously viewed ads of the selected user on the electronic device of the user, and display thumbnails of the ads after the ads play on the electronic device of the user.

FIG. 7D is the electronic device 700 with the display 702 that shows sharing advertisements of the selected users with other users. Consider the example in which the user follows actors John Smith and Jane Doe. The user can select and share these advertisements with other users or members. The display 702 shows advertisements of John Smith in a selection 760, advertisements of Jane Doe in a selection 762, and advertisements of the user in a selection 764. The user can scroll through these advertisements with arrows to select and determine which ones to transmit to other users. For example, an area 766 (entitled “Enter Recipients to Receive Selected Ads”) enables a user to enter names of recipients to receive the advertisements. A search box 770 enables a user to search for recipients. A comment box 772 enables a user to send a comment with the advertisement being sent to the selected other user.

With FIG. 7D, a user can share, swap, trade, send, and/or transmits advertisements of selected users with other users. Consider an example in which the user follows actor John Smith. A targeted advertisement is sent to and played on an HPED of John Smith while he is on location shooting a new movie. This targeted advertisement is also sent to the user with a notice that the advertisement is for John Smith. The user then views the advertisement on his HPED at a same time that John Smith views the advertisement on his HPED. The user then sends this advertisement to his friend via the user interface of FIG. 7D and includes a message (such as “Here's an ad that John Smith just viewed. He's shooting his new action movie. Enjoy.”).

FIG. 7E is an electronic device 780 with a display 782 that shows advertisement filtering. Users can filter and/or remove advertisements from being provided to other users.

Consider an example in which John Smith wants to limit what advertisements his followers are able to view. An advertisement may appear on the display of his electronic device, and John Smith does not want to share this advertisement with other users or allow other users to know that this advertisement appeared on his display. John Smith can filter or remove this advertisement from being displayed to other users. As such, users can determine which advertisements participate and which advertisements do not participate in the advertisement following and/or advertisement switching.

The display 782 shows examples of options that filter advertisements that users can select such that selected advertisements are not presented to ad followers. These options include filtering advertisements based on content of the ad (such as removing ads with a rating of parental guidance (PG), mature audience (MA), suggestive dialogue (D), language (L), violence (V), sex (S)), filtering advertisements based on a source or origin (such as removing ads that appear on a specific website or come from a specific advertising agency), filtering advertisements based on location (such as removing ads when the user views the ads at a certain geographical location), filtering advertisements based on products (such as removing ads directed to or associated with automobiles or another specified product), filtering advertisements based on time (such as not sharing any ads that appear on a user's electronic device during a certain time of day or for a designated period of time), filtering advertisements based on an electronic device (such as filtering any ad that appears on a specified HPED of the user), or other ad filter options.

Consider an example in which a sports figure has several thousand followers that view advertisements appearing on an HPED of the sports figure. While the sports figure is surfing the Internet, an unexpected advertisement pops-up on his HPED and begins to play. This advertisement contains violence and is inappropriate for many of his followers. The sports figure would not want his followers viewing this advertisement or even knowing that this advertisement appeared on his HPED, especially since the advertisement was not authorized by the sports figure and contains violent and inappropriate content. This advertisement would not be transmitted and/or shared with his followers since advertisements including violence and/or inappropriate language are filtered. The sports figure could designate that these types of advertisements are automatically filtered from being presented to his followers. The sports figure could view the advertisement on his device or at his website, but this advertisement would not participate in advertisement switching and/or following.

Consider an example in which two users (Paul and Alice) switch advertisements for one week. Paul decides to filter advertisements such that Paul only shares targeted advertisements with a comic theme. Sarah decides to filter advertisements such that Sarah only shares advertisements for feature length movies.

A user may or may not know which or when other users are viewing advertisements intended for and directed to the user. Consider an example in which a television personality has many followers. When a targeted advertisement appears on an HPED of the television personality, this advertisement also appears on HPEDs of his followers. A number of followers frequently change since new followers subscribe daily to be followers of the television personality. As such, the television personality may not know at any given time which one of his followers are following him.

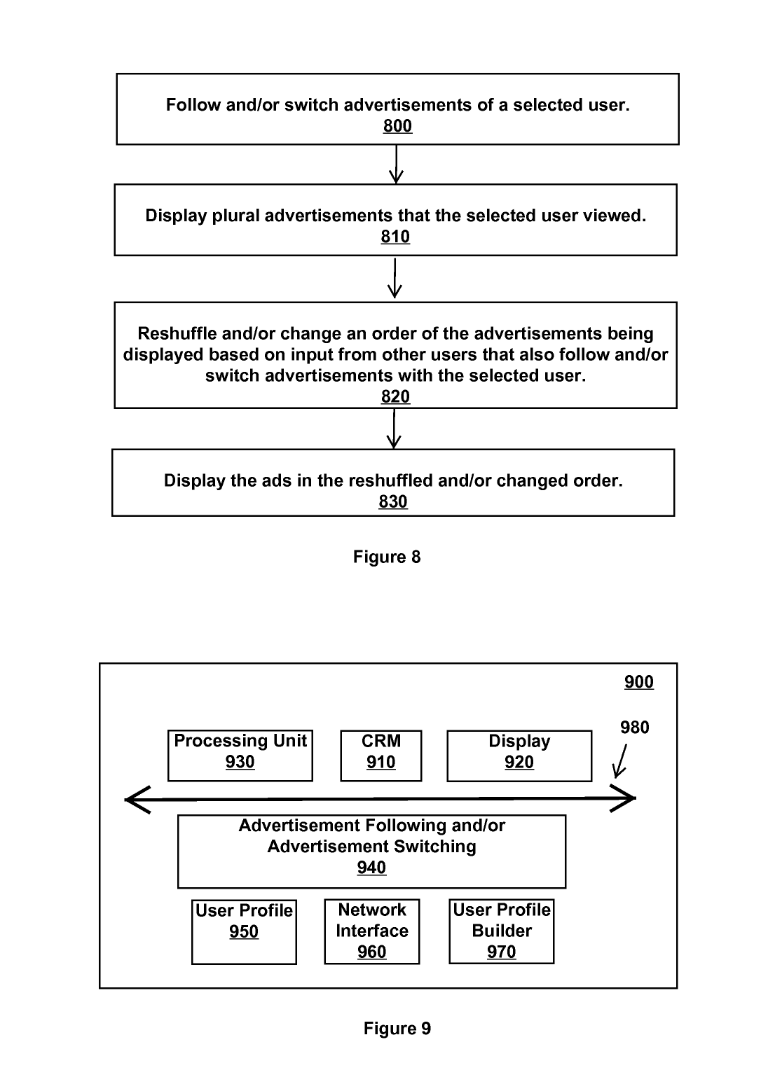

FIG. 8 is a method to reshuffle or change an order in which plural followed and/or switched advertisements are displayed to users.

Block 800 states follow and/or switch advertisements of a selected user. As discussed herein, advertisements of the selected user are then displayed and/or provided to the user.

Block 810 states display plural advertisements that the selected user viewed.

For example, the plural advertisements are displayed in a hierarchy, rating scheme, or a list. A user can readily see which advertisements that the selected user previously viewed without the user watching the advertisements. For instance, the advertisements are displayed as thumbnails or other visual indication to enable the user to visually distinguish the advertisements from each other. As such, a user can determine which advertisements of the selected user to watch and which advertisements to disregard and not watch.

Block 820 states reshuffle and/or change an order of the advertisements being displayed based on input from other users that also follow and/or switch advertisements with the selected user.

Block 830 states display the ads in the reshuffled and/or changed order.

Consider an example in which a celebrity has thousands or hundreds of thousands of users that follow which advertisements the celebrity views. When this celebrity views a video advertisement (such as an ad playing on an HPED of the celebrity or an ad that plays on a website that the celebrity is viewing), then this advertisement automatically plays on electronic devices of the users that follow this celebrity. After an advertisement plays, the users can rate the advertisement and/or provide feedback and/or an indication whether they liked the advertisement (such as indicating they liked the advertisement by viewing its entirety or indicating they did not like the advertisement by now viewing it). Feedback from the users thus provides a rating or ranking for the advertisements. This feedback also assists in ordering how the advertisements are presented on the displays of the users following the celebrity. For instance, three previously viewed advertisements of the celebrity are presented on the displays of the users. These three advertisements are presented as thumbnails in a sidebar area with a first or top ad being most popular with the users, a second or middle ad being second most popular with the users, and a third or bottom ad being third most popular with the users. An order of these advertisements changes as additional feedback is received. For instance, the top ad moves to the second position, and the second ad becomes the most popular and moves to the top position. This order of advertisements changes on the displays of followers of the celebrity. Additionally, new advertisements play to the celebrity are ranked and replace the existing thumbnails presented on the displays of the users. As such, the order, ranking, rating, and/or hierarchy of the displayed advertisements to the followers change over time as users following the celebrity provide feedback on the advertisements of the celebrity.

FIG. 9 is an electronic device 900 in accordance with an example embodiment. The electronic device includes components of computer readable medium (CRM) or memory 910, a display 920, a processing unit 930, advertisement following and/or advertisement switching 940 (such as software program and/or hardware), a user profile 950, a network interface 960, a user profile builder 970, and one or more buses or communication paths 980. FIG. 9 shows these components in a single electronic device. Alternatively, one or more of these components can be distributed or included in various electronic devices, such as some components being included in an HPED, some components being included in a server, some components being included in storage accessible over the Internet, components being in various different electronic devices that are spread across a network, etc.

The processor unit 930 includes a processor (such as a central processing unit, CPU, microprocessor, application-specific integrated circuit (ASIC), etc.) for controlling the overall operation of memory 910 (such as random access memory (RAM) for temporary data storage, read only memory (ROM) for permanent data storage, and firmware). The processing unit 930 communicates with memory 910 and performs operations and tasks that implement one or more blocks of the flow diagrams discussed herein. The memory 910, for example, stores applications, data, programs, algorithms (including software to implement or assist in implementing example embodiments) and other data.

The network interface 960 provides a mechanism for the electrical device 900 to communicate with other electrical devices, computers, users, or systems. For example, the network interface 960 enables the electrical device to transmit data through a wired or wireless connection to a network, such as the Internet and/or a cellular network.

Blocks and/or methods discussed herein can be executed and/or made by a user, a user agent of a user, a software application, an electronic device, a computer, a computer system, and/or an intelligent personal assistant.

As used herein, the term “information” includes communication and/or reception of knowledge and/or intelligence, and knowledge obtained from investigation, study, and/or instruction. Information also includes data, such as information in numerical form that can be digitally transmitted and/or processed. Thus, information includes raw data and unorganized facts that can be processed, and also includes processed, organized, and structured, such as data being processed and presented in a useful context.

As used herein, “private information” includes information pertaining to a user's behavior, actions, and/or communication that occurs in a context in which an individual can reasonably expect privacy, information provided by an individual for a specific purpose and for which the individual can reasonably expect will not be made public (for example, an email between two friends or medical records), and/or information that is not known or intended to be known publicly. Private information can be known by a single person (such as a user knowing a secret about himself or herself), or it can be known to more than one person and still be private (such as personal information about a user that is known to the user, the user's family, and the user's friends but not known to the public or not readily accessible to the public).

As used herein, a “product” is something produced by human effort, mechanical effort, and/or a natural process. The term product can also include a service that is an act or work performed for a user and for pay.

As used herein, a “social network” is a social structure in which users communicate with each other over a network with electronic devices. The social network facilitates the building of social relations among users who share backgrounds, familial relations, business relations, interests, and/or connections. The social network includes one or more of representations and/or information about the users (such as user profiles, photos, videos, etc.) and a platform (such as a web-based platform) that allows the users to communicate with each other over one or more networks (such as using email and/or instant messages over the Internet) and/or share information with other users in the social network.

As used herein, “target advertising” and “target advertisement” and “target video advertisement” are advertising in which advertisements are directed to a consumer based on personal traits or personal preferences of the consumer, such as demographics, psychographics (personality, values, attitudes, interests, and lifestyles), purchase history, and/or user profile.

As used herein, a “user” is a human being, a person.

As used herein, a “user profile” is personal data that represents an identity of a specific person or organization. The user profile includes information pertaining to the characteristics and/or preferences of the user. Examples of this information for a person include, but are not limited to, one or more of personal data of the user (such as age, gender, race, ethnicity, religion, hobbies, interests, income, employment, education, etc.), photographs (such as photos of the user, family, friends, and/or colleagues), videos (such as videos of the user, family, friends, and/or colleagues), and user-specific data that defines the user's interaction with and/or content on an electronic device (such as display settings, application settings, network settings, stored files, downloads/uploads, browser activity, software applications, user interface or GUI activities, and/or privileges).

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Method blocks discussed herein can be automated and executed by a computer, computer system, user agent, and/or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1. A method executed in a computer system, comprising:
commencing, in the computer system, a video communication over a network between a first user with an electronic and a second user with an electronic device;
retrieving, by the computer system, a targeted video advertisement intended for the first user and based on personal preferences of the first user;
retrieving, by the computer system, a targeted video advertisement intended for the second user and based on personal preferences of the second user; and
switching advertisements such that the targeted video advertisement intended for the first user plays on a display of the electronic device of the second user, and the targeted video advertisement intended for the second user plays on a display of the electronic device of the first user while the first and second users conduct the video communication over the network.

2. The method of claim 1 further comprising:
simultaneously playing the targeted video advertisements at a same time such that the targeted video advertisement intended for the second user plays on the display of the electronic device of the first user simultaneously while the targeted video advertisement intended for the first user plays on the display of the electronic device of the second user.

3. The method of claim 1, wherein the targeted video advertisement intended for the first user plays to the second user but not the first user, and the targeted video advertisement intended for the second user plays to the first user but not the second user.

4. The method of claim 1, wherein the first and second users are unaware that the targeted video advertisements are switched such that the targeted video advertisement intended for the first user plays on the display of the electronic device of the second user and the targeted video advertisement intended for the second user plays on the display of the electronic device of the first user.

5. The method of claim 1 further comprising:
notifying the first user that the targeted video advertisement playing on the display of the electronic device of the first user is a targeted advertisement intended for the second user;
notifying the second user that the targeted video advertisement playing on the display of the electronic device of the second user is a targeted advertisement intended for the first user.

6. The method of claim 1 further comprising:
displaying, on the display of the electronic device of the first user and in a hierarchical format, thumbnails of advertisements that the second user previously viewed on the display of the electronic device of the second user.

7. The method of claim 1 further comprising:
displaying, on the display of the electronic device of the first user, a list of other users with whom the first user can switch advertisements;
selecting one of the other users such that an advertisement being viewed by the one of the other users will appear on the display of the electronic device of the first user, wherein electronic devices of the first user and the other users execute an advertisement switching software program.

8. A computer system, comprising:
one or more memories that store instructions; and
a processing unit that executes the instructions to:
search for members of a group that participate in advertisement following in which the members can view advertisements that the members are currently viewing and view advertisements that the members previously viewed;
select plural members of the group whose targeted advertisements are viewed and followed by one member of the group;
provide, on an electronic device of the one member, a notice when a targeted advertisement is being viewed by one of the plural members; and
display, on the electronic device of the one member, the targeted advertisement such that the targeted advertisement simultaneously plays on the electronic device of the one member and on an electronic device of the one of the plural members.

9. The computer system of claim 8, wherein the processing unit further executes the instructions to:
display, on the electronic device of the one member, names of the plural members, an advertisement last viewed by each of the plural members, and a list of advertisements previously viewed by each of the plural members.

10. The computer system of claim 8, wherein the processor further executes the instructions to:
display, on the electronic device of the one member, names of the members of the group that participate in the advertisement following such that the one member can select names of the plural members.

11. The computer system of claim 8, wherein when the targeted advertisement begins to play on the electronic device of the one of the plural members, the targeted advertisement automatically plays in full screen and over open windows on the electronic device of the one member.

12. The computer system of claim 8, wherein the notice to the electronic device of the one member is provided in real-time while the targeted advertisement is being viewed by one of the plural members on an electronic device of the one of the plural members.

13. The computer system of claim 8, wherein the one of the plural members is a celebrity having thousands of the members of the group that participate in the advertisement following such that when the celebrity views an advertisement, the advertisement simultaneously plays on electronic devices of the thousands of the members of the group.

14. The computer system of claim 8, wherein the targeted advertisement that plays on the electronic device of the one member includes a name of the one of the plural members so the one member can identify the targeted advertisement as originating from the one of the plural members.

15. A non-transitory computer readable storage medium storing instructions that cause a computer system to execute a method, comprising:
display members of a group that participate in advertisement following in which the members can view advertisements that the members are currently viewing and view advertisements that the members previously viewed;
receive, from a first member of the group, a selection to follow targeted advertisements that are directed a second member of the group;
display, to the first member of the group, the targeted advertisements that are directed to the second member of the group; and
provide, to the first member of the group, a notice that indicates the targeted advertisements that are directed to the second member of the group, wherein the targeted advertisements directed to the second member of the group are simultaneously displayed to the first member of the group and to the second member of the group.

16. The non-transitory computer readable storage medium storing instructions of claim 15, wherein the targeted advertisements are based on personal preferences of the second member of the group and not based on personal preferences of the first member of the group.

17. The non-transitory computer readable storage medium storing instructions of claim 15, wherein the notice includes a name of the second member of the group so the first member can determine to whom the targeted advertisements are directed.

18. The non-transitory computer readable storage medium storing instructions of claim 15 further to cause the computer system to execute the method comprising:
display, on an electronic device of the first member, the targeted advertisements in a hierarchy that is based on a number of the members in the group that viewed the targeted advertisements.

19. The non-transitory computer readable storage medium storing instructions of claim 15 further to cause the computer system to execute the method comprising:
receive, from the second member of the group, instructions to filter a category of advertisements from being transmitted to the first member of the group and to other members of the group;
display advertisements in the category to the second member of the group without displaying the advertisements in the category to the first member and to the other members of the group.

20. The non-transitory computer readable storage medium storing instructions of claim 15 further to cause the computer system to execute the method comprising:
receive, from the second member of the group, a selection to follow targeted advertisements that are directed the first member of the group;
display, to the second member of the group, the targeted advertisements that are directed to the first member of the group; and
provide, to the second member of the group, a notice that indicates the targeted advertisements that are directed to the first member of the group.
